(19) United States
(12) Patent Application Publication
(10) Pub. No.: US 2009/0132074 A1
(43) Pub. Date: May 21, 2009

(54) AUTOMATIC SEGMENT EXTRACTION SYSTEM FOR EXTRACTING SEGMENT IN MUSIC PIECE, AUTOMATIC SEGMENT EXTRACTION METHOD, AND AUTOMATIC SEGMENT EXTRACTION PROGRAM

(75) Inventor: Akio Yamada, Tokyo (JP)

Correspondence Address: YOUNG & THOMPSON, 209 Madison Street, Suite 500, ALEXANDRIA, VA, 22314, US

(73) Assignee: NEC Corporation

(21) Appl. No.: 12/096,763

(22) PCT Filed: Oct. 6, 2006
(86) PCT No.: PCT/JP2006/320073

§ 371 Date: Jun. 9, 2008

(30) Foreign Application Priority Data
Dec. 8, 2005 (JP) 2005-354285

(51) Int. Cl. G06F 17/00

(52) U.S. Cl. 700/94

(57) ABSTRACT

A segment automatic extracting system provides applications with an impressive segment of a musical composition as metadata on the composition by extracting a portion of the composition likely to be widely known by general users irrespective of the number of appearances in the composition. Associated method and program are also described. A first acoustic signature (AS) creating section creates an AS representing the feature value of the acoustic signal of each of contents. An important segment extracting section creates an acoustic segment signature representing the frequently appearing feature value from searching all created ASs. A second AS creating section creates an AS from the composition signal. A common segment extracting section judges whether each acoustic segment signature agrees with a part of the AS of the composition signal and outputs time information by which the AS of the musical signal agreeing with the AS can be specified.

### TECHNICAL FIELD

The present invention relates to an automatic segment extraction system for automatically extracting an impressive segment in a music piece, an automatic segment extraction method and an automatic segment extraction program.

### BACKGROUND ART

Patent Document 1 discloses an example of a segment extraction system for extracting a characteristic segment from audio data of a music piece.

FIG. 1 is a block diagram showing a configuration example of a conventional segment extraction system. As shown in FIG. 1, the conventional segment extraction system is provided with small frame division means 501, frame feature value extraction means 502, frame feature value comparison means 503, common segment extraction means 504, and post-processing means 505.

The conventional segment extraction system having such a configuration operates as follows.

Small frame division means 501 divides an inputted audio signal into a plurality of frames. Note that, a frame is an individual element generated by separating audio data by a small time interval.

Next, frame feature value extraction means 502 generates a 12 dimensional vector characterizing an audio signal for each frame. Frame feature value comparison means 503 calculates the degree of similarity between frames by comparing individual 12 dimensional vectors of all frames constituting a music piece. Frame feature value comparison means 503 generates a list showing pairs of the same or nearly identical frames by processing the obtained degrees of similarity based on a threshold.

Common segment extraction means 504 can extract a phrase which occurs repeatedly in the music piece by extracting a segment in which the same frame occurs in the same order.

Finally, post-processing means 505 selects a portion corresponding to the assumed definition of “charm” from the repeatedly occurring phrases and automatically extracts the portion as a characteristic segment in the music piece.

Patent Document 2 discloses an example of a video recorder capable of easily retrieving a climax scene and an important scene in a TV broadcast program in which BGM (Background Music) is often heard and of reproducing the program from the scene.

Patent Document 3 discloses an example of an anteroposterior search result use type similar music search device that is capable of retrieving a voice music signal including unsteady noise with a good precision and at a high speed when the voice music signal is retrieved with temporally continuous search keys.

Patent Documents 4 and 5 disclose an example of a technique for finding a portion common to between feature value strings stored together with time information by comparing partial portions thereof.

Patent Document 1: Japanese Patent Laid-Open No. 2004-233965 (Paragraphs 0038-0045)

Patent Document 2: Japanese Patent Laid-Open No. 2004-140675 (Paragraphs 0010-0012)

Patent Document 3: Japanese Patent Laid-Open No. 2004-333605 (Paragraphs 0022-0028)

Patent Document 4: Japanese Patent No. 3451985 (Paragraphs 0020-0023)

Patent Document 5: Japanese Patent Laid-Open No. 2003-196658 (Paragraphs 0028-0030)

### DISCLOSURE OF THE INVENTION

### Problems to be Solved by the Invention

Existing segment extraction methods have a problem in that not all segments that are impressive to general users can always be automatically extracted.

According to the method of Patent Document 1, attention is focused on the periodicity of a melody in a music piece and “impressive segment (called charm)” is extracted by automatically extracting repeated melodies.

Unfortunately, since a frequently repeated portion is just selected, the portion is not exactly an impressive segment recognized by a user.

It is desirable that even if a short phrase occurs only once in a music piece, if the user has heard the short phrase several times actively or passively, the short phrase should be defined as an impressive segment.

Alternatively, it is desirable that even if the user has heard a short phrase only once, if the user hears the short phrase and if the user has been impressed, for example, by its related video and other media, the short phrase should be defined as an impressive segment.

According to the video recorder of Patent Document 2, a voice signal in a TV broadcast program is checked to detect the BGM start position and a BGM switched position and generates a thumbnail image of the detected position.

Unfortunately, the generated thumbnail image is just the BGM start position and the BGM switched position. It is impossible to recall a configuration for extracting a segment in a music piece based on a technique related to such a search process.

According to the similar music search device of Patent Document 3, in a case where a feature value of a plurality of temporally continuous signals such as individual signal portions serially extracted from a voice music signal is used as a search key, the portions similar to the search key are retrieved at a high speed. Therefore, an impressive segment recognized by the user is not always retrieved.

In view of this, it is an object of the present invention to provide an automatic segment extraction system, an automatic segment extraction method and an automatic segment extraction program that is capable of automatically extracting portions which are assumed to have a high possibility of being widely recognized by general users regardless of the number of occurrences thereof in a music piece and that is capable of providing the extracted portions to various applications as impressive segments in a music piece.

### Means for Solving the Problems

The automatic segment extraction system in accordance with the present invention, which is an automatic segment extraction system for automatically extracting information indicating an impressive segment of a music piece, includes a frequent segment extraction portion which determines a segment containing a portion of an audio signal occurring repeatedly in one or more pieces of content information including the audio signal as a frequent segment and extracts the frequent segment; a common segment determination portion which determines whether or not a frequent segment extracted by the frequent segment extraction portion exists in a music signal including an audio signal; and a common segment output portion which outputs information capable of determining a segment of the music signal corresponding to the frequent segment if the common segment determination portion determines that the frequent segment exists in the music signal.

The frequent segment extraction portion may be configured to generate audio segment identification information capable of identifying an individual segment of an audio signal in content information separated by a predetermined condition and to extract the audio segment identification information for determining the frequent segment as frequent segment identification information; the common segment determination portion may be configured to generate music segment identification information capable of identifying an individual segment of a music signal separated by a predetermined condition and to compare the frequent segment identification information and the music segment identification information; and if the frequent segment identification information matches any one of the pieces of the music segment identification information, the common segment output portion may be configured to output information indicating the matched music segment identification information.

According to such a configuration, an impressive segment can be automatically extracted under a predetermined condition for separating content and a music signal.

The audio segment identification information and the music segment identification information are information including a feature value; the frequent segment extraction portion may determine the frequent segment by comparing individual feature values contained in individual audio segment identification information; the common segment determination portion may compare the feature value contained in the frequent segment identification information and the individual feature value contained in individual music segment identification information; and if the feature value contained in the frequent segment identification information matches any one of the individual feature values contained in the individual music segment identification information, the common segment output portion may output information indicating the matched music segment identification information.

According to such a configuration, an impressive segment can be automatically extracted by comparing feature values.

A second extraction portion may be further included which generates second frequent segment identification information containing the same kind of feature values as the feature values contained in the music segment identification information based on the frequent segment identification information extracted by the frequent segment extraction portion; the common segment determination portion may be configured to generate the music segment identification information containing feature values different from the feature values contained in the frequent segment identification information extracted by the frequent segment extraction portion and to compare the feature values contained in the second frequent segment identification information and the individual feature values contained in the music segment identification information.

According to such a configuration, the process related to frequent segment extraction with a large number of processes can be simplified, while the processing precision can be maintained by precisely performing a process of comparing the feature values.

The frequent segment extraction portion may extract the frequent segment according to the inputted weight information.

According to such a configuration, an impressive segment can be automatically extracted under the weight information.

The frequent segment extraction portion may include a first filtering portion for restricting a band of an audio signal of the content information; and the common segment determination portion may include a second filtering portion for restricting a band of an audio signal of the music signal.

According to such a configuration, an impressive segment can be extracted automatically and accurately even if noise is mixed in content information or a music signal.

The frequent segment extraction portion may include a subset generation portion which extracts a plurality of pieces of content information by a predetermined criterion.

According to such a configuration, an impressive segment can be automatically extracted as a target of specific content.

The content information is a TV broadcast program and the subset generation portion may extract a TV broadcast program belonging to the same series.

According to such a configuration, an impressive segment can be automatically extracted as a target of TV broadcast programs belonging to the same series.

The automatic segment extraction method in accordance with the present invention, which is an automatic segment extraction method for use in the automatic segment extraction system for automatically extracting information indicating an impressive segment of a music piece, includes a frequent segment extraction step of determining a segment containing a portion of an audio signal occurring repeatedly in one or more pieces of content information including the audio signal as a frequent segment and extracting the frequent segment; a common segment determination step of determining whether or not the frequent segment extracted by the frequent segment extraction exists in a music signal including an audio signal; and a common segment outputting step of outputting information capable of determining a portion of the music signal corresponding to the frequent segment if the common segment determination determines that the frequent segment exists in the music signal.

The frequent segment extraction step may include generating audio segment identification information capable of identifying an individual segment of an audio signal in content information separated by a predetermined condition and extracting the audio segment identification information for determining the frequent segment as frequent segment identification information; the common segment determination step may include generating music segment identification information capable of identifying an individual segment of a music signal separated by a predetermined condition and comparing the frequent segment identification information and the music segment identification information; and if the frequent segment identification information matches any one of the pieces of the music segment identification information the common segment outputting step may include outputting information indicating the matched music segment identification information.

According to such a configuration, an impressive segment can be automatically extracted under a predetermined condition for separating content and a music signal.

The audio segment identification information and the music segment identification information are information including a feature value; the frequent segment extraction step may include determining the frequent segment by comparing individual feature values contained in individual audio segment identification information; the common segment determination step may include comparing the feature value contained in the frequent segment identification information and the individual feature value contained in individual music segment identification information, and if the feature value contained in the frequent segment identification information matches any one of the individual feature values contained in the music segment identification information, the common segment outputting step may include outputting information indicating the matched music segment identification information.

According to such a configuration, an impressive segment can be automatically extracted by comparing feature values.

Second frequent segment extraction step may be further included which includes generating second frequent segment identification information containing the same kind of feature values as the feature values contained in the music segment identification information based on the frequent segment identification information extracted by the frequent segment extraction step; the common segment determination step may include generating the music segment identification information containing feature values that are different from the feature values contained in the frequent segment identification information extracted by the frequent segment extraction and comparing the feature values contained in the second frequent segment identification information and the individual feature values contained in the music segment identification information.

According to such a configuration, the process related to frequent segment extraction with a large number of processes can be simplified, while the processing precision can be maintained by precisely performing a process of comparing the feature values.

The frequent segment extraction step may include extracting the frequent segment according to the inputted weight information.

According to such a configuration, an impressive segment can be automatically extracted based on the weight information.

First filtering step of restricting a band of an audio signal of the content information and second filtering step of restricting a band of an audio signal of the music signal are further included; the frequent segment extraction step may include determining as the frequent segment a segment containing a portion of an audio signal occurring repeatedly in content information where the band of the audio signal is restricted by the first filtering step and extracting the frequent segment; and the common segment determination step may include determining whether or not the frequent segment extracted by the frequent segment extraction step exists in a music signal where the band of the audio signal is restricted by the second filtering step.

According to such a configuration, an impressive segment can be extracted automatically and accurately even if noise is mixed in content information or in a music signal.

A subset generation step of extracting a plurality of pieces of content information by a predetermined criterion is further included; the frequent segment extraction step may include determining as the frequent segment a segment containing a portion of an audio signal occurring repeatedly in a plurality of pieces of content information extracted by the subset generation step and extracting the frequent segment.

According to such a configuration, an impressive segment can be automatically extracted as a target of specific content.

The content information is a TV broadcast program and the subset generation step may include extracting a TV broadcast program belonging to the same series.

According to such a configuration, an impressive segment can be automatically extracted as a target of TV broadcast programs belonging to the same series.

The automatic segment extraction program in accordance with the present invention, which is an automatic segment extraction program for causing a computer to execute a process of automatically extracting information indicating an impressive segment of a music piece, causes the computer to execute a frequent segment extraction process of determining a segment containing a portion of an audio signal occurring repeatedly in one or more pieces of content information including the audio signal as a frequent segment and extracting the frequent segment to execute; a common segment determination process of determining whether or not a frequent segment extracted by the frequent segment extraction process exists in a music signal including an audio signal; and to execute a common segment output process of outputting information capable of determining a portion of the music signal corresponding to the frequent segment if the common segment determination process determines that the frequent segment exists in the music signal.

The frequent segment extraction process may include generating audio segment identification information capable of identifying an individual segment of an audio signal in content information separated by a predetermined condition and extracting the audio segment identification information for determining the frequent segment as frequent segment identification information; the common segment determination process may include generating music segment identification information capable of identifying an individual segment of a music signal separated by a predetermined condition and comparing the frequent segment identification information and the music segment identification information; and if the frequent segment identification information matches any one of the pieces of the music segment identification information, the common segment output process may include outputting information indicating the matched music segment identification information.

According to such a configuration, an impressive segment can be automatically extracted under a predetermined condition for separating content and a music signal.

The audio segment identification information and the music segment identification information are information including a feature value; the frequent segment extraction process may include determining the frequent segment by comparing individual feature values contained in individual audio segment identification information; the common segment determination process may include comparing the feature value contained in the frequent segment identification information and the individual feature value contained in individual music segment identification information; and if the feature value contained in the frequent segment identification information matches any one of the individual feature values contained in the music segment identification information, the common segment output process may include outputting information indicating the matched music segment identification information.

According to such a configuration, an impressive segment can be automatically extracted by comparing feature values.

The computer may be further caused to execute a second frequent segment extraction process of generating a second frequent segment identification information containing the same kind of feature values as the feature values contained in the music segment identification information based on the frequent segment identification information extracted by the frequent segment extraction process; the common segment determination process may include generating the music segment identification information containing feature values that are different from the feature values contained in the frequent segment identification information extracted by the frequent segment extraction process and comparing the feature values contained in the second frequent segment identification information and the individual feature values contained in the music segment identification information.

According to such a configuration, the process related to frequent segment extraction with a large number of processes can be simplified, while the processing precision can be maintained by precisely performing a process of comparing the feature values.

The frequent segment extraction process may include extracting the frequent segment according to the inputted weight information.

According to such a configuration, an impressive segment can be automatically extracted based on the weight information.

The computer may be further caused to execute a first filtering process of restricting a band of an audio signal of the content information and a second filtering process of restricting a band of an audio signal of the music signal; and the frequent segment extraction process may include determining as the frequent segment a segment containing a portion of an audio signal occurring repeatedly in content information where the band of an audio signal is restricted by the first filtering process and extracting the frequent segment; the common segment determination process may include determining whether or not the frequent segment extracted by the frequent segment extraction step exists in a music signal where the band of an audio signal is restricted by the second filtering process.

According to such a configuration, an impressive segment can be extracted automatically and accurately even if noise is mixed in content information or a music signal.

Further, the computer may be caused to execute a subset generation process of extracting a plurality of pieces of content information according to a predetermined criterion and the frequent segment extraction process may include determining a segment containing a portion of an audio signal occurring repeatedly in a plurality of pieces of content information extracted by the subset generation process as the frequent segment and extracting the frequent segment.

According to such a configuration, an impressive segment can be automatically extracted as a target of specific content.

The content information is a TV broadcast program and the subset generation process may include extracting a TV broadcast program belonging to the same series.

According to such a configuration, an impressive segment can be automatically extracted as a target of TV broadcast programs belonging to the same series.

A preferred exemplary embodiment of the automatic segment extraction system in accordance with the present invention is, for example, provided with means of generating a segment signature feature value for identifying a portion by investigating a music segment frequently exposed to a user from a content group using a music piece internally; means of generating a signature feature value for identifying a partial segment of a music piece to be analyzed; and common segment extraction means of determining a common portion by comparing the two signature feature values.

According to such a configuration, a portion frequently presented to viewers through various media in a music piece can be identified automatically and uniquely and an object of the present invention can be achieved.

### ADVANTAGES OF THE INVENTION

The present invention has an advantage capable of automatically extracting a portion assumed to have a high possibility of being widely recognized by general users regardless of the number of occurrences in a music piece and capable of providing the portion to various kinds of applications as an impressive segment in the music piece. In other words, the present invention has an advantage capable of analyzing music content using content such as a TV broadcast program.

### BRIEF DESCRIPTION OF THE DRAWINGS

FIG. 1 is a block diagram showing a configuration example of a conventional segment extraction system;

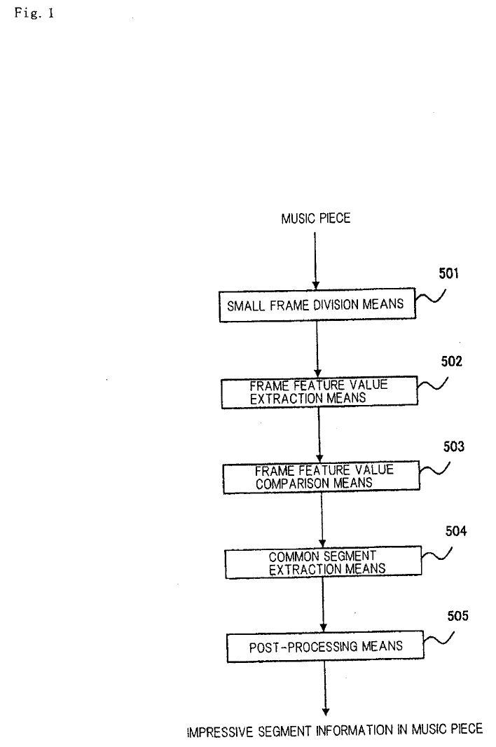

FIG. 2 is a block diagram showing a first exemplary embodiment of the automatic segment extraction system in accordance with the present invention;

FIG. 3 is a block diagram showing a second exemplary embodiment of the automatic segment extraction system in accordance with the present invention;

FIG. 4 is a block diagram showing a third exemplary embodiment of the automatic segment extraction system in accordance with the present invention; and

FIG. 5 is a block diagram showing a fourth exemplary embodiment of the automatic segment extraction system in accordance with the present invention.

### DESCRIPTION OF SYMBOLS

100, 200 Segment information generation portion
101 Audio signature generation portion
102 Important segment extraction portion
111, 211 Audio signature generation portion
112 Common segment extraction portion
201 Audio segment signature generation portion

### BEST MODE FOR CARRYING OUT THE INVENTION

### First Exemplary Embodiment

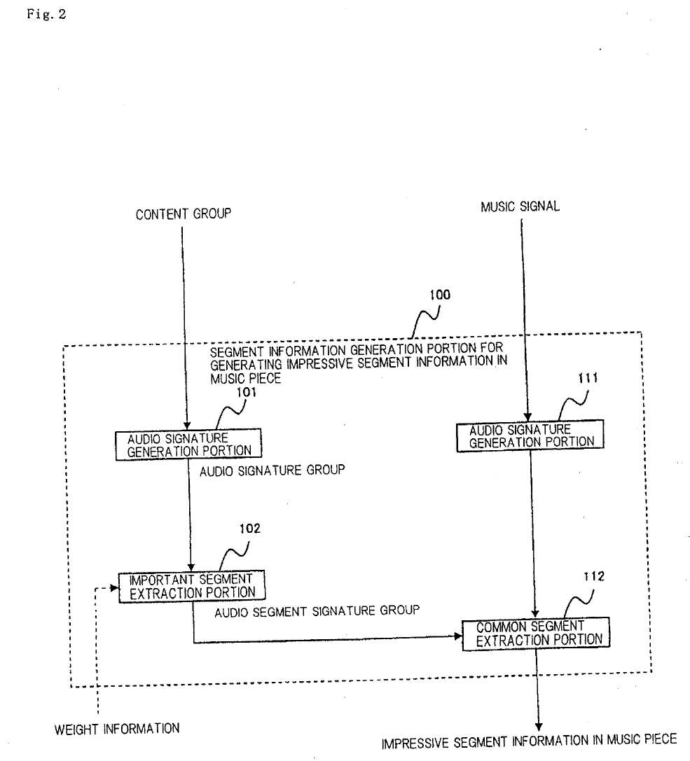

Hereinafter, a first exemplary embodiment will be described with reference to drawings. FIG. 2 is a block diagram showing the first exemplary embodiment of the automatic segment extraction system in accordance with the present invention. The automatic segment extraction system shown in FIG. 2 includes segment information generation portion 100 for generating information about an impressive segment in a music piece.

Segment information generation portion 100 includes first audio signature generation portion 101, important segment extraction portion 102, second audio signature generation portion 111, and common segment extraction portion 112. Note that first audio signature generation portion 101 and important segment extraction portion 102 constitute the frequent segment extraction portion; and second audio signature generation portion 111 and common segment extraction portion 112 constitute the common segment determination portion; and common segment extraction portion 112 constitutes the common segment output portion.

Segment information generation portion 100 generates segment information indicating impressive segment in a music piece based on a music signal and a content group that is using the music piece internally.

The impressive segment refers to a widely recognized portion such as a phrase (e.g., a melody line) that occurs frequently in a content group.

It should be noted that the following description uses a music signal to refer to a part of music piece or an entire music piece.

The music signal refers to an audio signal for a general music piece and is stored in, for example, a corresponding area of a database (not shown).

The content group refers to a content set including a music signal and for example, includes video content with a voice representative of a TV broadcast program or an internet resource with a background music such as a Web page or a blog.

The content group is selected, for example, according to a music signal or at random by a manager or the like of the automatic segment extraction system. The selected content group is downloaded through a communication network to the automatic segment extraction system.

When the content group is inputted, first audio signature generation portion 101 generates an audio signature which is metadata for identifying an audio track (audio signal) for all content.

The audio signature is composed of a set of pairs of time information and a music feature value in the time arranged in chronological order. In other words, the music signature refers to audio segment identification information for identifying an individual segment of an audio signal in content information separated by a predetermined condition.

With respect to an audio signature, various representation forms of a feature value have been developed as the audio signature.

For example, a preferred implementation example of an audio signature is shown in Section 6.2 of International Standard (ISO/IEC 15938-4) known as MPEG-7 audio co-developed by ISO and IEC. More specifically, the audio signature refers to information of a music feature value stored serially in chronological order together with time information for each piece of content.

Important segment extraction portion 102 searches for a portion of an audio signal (hereinafter referred to as “an audio signal portion”) frequently occurring in one or more pieces of content based on a plurality of audio signatures generated by audio signature generation portion 101. Important segment extraction portion 102 outputs the audio signal portion as an audio segment signature. The audio segment signature is an example of frequent segment identification information and refers to a widely recognized phrase.

Important segment extraction portion 102 retrieves not only a music feature value repeatedly occurring in an audio signature of one piece of content but also a music feature value included that is common to a plurality of pieces of content.

Therefore, important segment extraction portion 102 can extract a phrase which occurs only once in one piece of content but occurs common to various pieces of content, as a widely recognized phrase, or an audio segment signature.

Examples of techniques, which important segment extraction portion 102 uses to perform a comparison between a portion and another portion (part-part comparison) to find a portion common to the feature value strings having time information such as an audio signature, include techniques disclosed by Patent Documents 4 and 5, aforementioned international standards (ISO/IEC 15938-4) and the like.

Important segment extraction portion 102 generates an audio segment signature including a piece of time information for identifying an audio signal portion frequently occurring in a content group and a music feature value of a frequently occurring audio signal portion. In other words, the audio segment signature refers to an audio signature corresponding to a segment including an audio signal portion (e.g., a phrase) frequently occurring in a content group.

Important segment extraction portion 102 generates a plurality of audio segment signatures for identifying an audio signal portion group repeated in the inputted content group by performing the above process on the plurality of inputted audio signatures.

Important segment extraction portion 102 assigns a degree of importance to the generated audio segment signature.

The simplest example of the degree of importance is the number of repetitions.

It should be noted that the degree of importance is not limited to the number of repetitions, but is arbitrarily changeable.

For example, instead of simply counting the number of repetitions, important segment extraction portion 102 may allow weight information to be inputted from outside, add a piece of weight information corresponding to an individual segment for each repeated segment and use the total sum of the pieces of weight information as the degree of importance of the segment.

The weight information is an objective index value such as an hourly viewer rating or a predetermined index value for the individual content position. The weight information refers to an artificial pattern such as an index value where a low value is assigned for an introduction portion and a high value is assigned for a position where the producer sets a climax such as a position before a commercial is inserted and in the vicinity of the ending.

It should be noted that in the following description, a plurality of audio segment signatures generated by important segment extraction portion 102 may be written as an audio segment signature group.

On the other hand, another input, i.e., a music signal is inputted into second audio signature generation portion 111.

Second audio signature generation portion 111 generates an audio signature including the same kind of music feature value as used by audio signature generation portion 101 from an inputted music signal. In other words, second audio signature generation portion 111 generates an audio signature, i.e., metadata for identifying the inputted music signal.

The audio signature is an example of music segment identification information for identifying an individual segment of a music signal separated under a predetermined condition.

Both the audio signature of a music signal generated by second audio signature generation portion 111 and the audio segment signature group generated by important segment extraction portion 102 are inputted into common segment extraction portion 112.

Common segment extraction portion 112 determines a segment containing a portion of the audio signature of a music signal corresponding to an individual audio segment signature contained in an audio segment signature group and outputs time information (segment information) of the determined segment.

In other words, common segment extraction portion 112 compares the music feature value contained in an individual audio segment signature and the music feature value contained in the audio signature of a music signal. If the audio segment signature matches a portion of the audio signature of a music signal in terms of a music feature value, common segment extraction portion 112 outputs time information capable of identifying the matched portion of the music signal.

It should be noted that in the following description, the music signal having the matched portion may be written as a common segment.

Common segment extraction portion 112 determines the presence or absence of a common segment by performing a comparison between the portion and the all, i.e., a comparison between an audio segment signature and the audio signature of a music signal generated for a music piece. If a common segment is found, common segment extraction portion 112 outputs time information capable of identifying the common segment. The comparison between the portion and the all is exactly equivalent to the above described comparison between a portion and another portion from a technical point of view.

Unless all audio segment signatures match the audio signature of a music signal, common segment extraction portion 112 does not output the time information of a common segment.

The case in which the time information of a common segment is not outputted implies that the inputted music signal does not have a frequently used portion in the inputted content group, which implies that there is no impressive segment in the music signal.

It should be noted that the automatic segment extraction system can be implemented by a computer. The individual configuration portions constituting the automatic segment extraction system, i.e., segment information generation portion 100, first audio signature generation portion 101, important segment extraction portion 102, second audio signature generation portion 111 and common segment extraction portion 112 can be implemented by a program for causing the central processing unit (CPU) of a computer to execute the aforementioned functions.

The program is recorded in, for example, a computer-readable recording medium (e.g., memory). In this case, the central processing unit (CPU) of a computer reads the program from the recording medium and executes the read program.

It is applicable not only to the first exemplary embodiment but also to the following individual exemplary embodiments in which the individual configuration portions constituting the automatic segment extraction system can be implemented by a computer and can also be implemented by a program and the program is recorded in a recording medium.

As described above, the first exemplary embodiment has an advantage in that it is capable of selecting a phrase which a user has frequently heard as an impressive segment in a music piece regardless of the internal structure of the music piece.

### Second Exemplary Embodiment

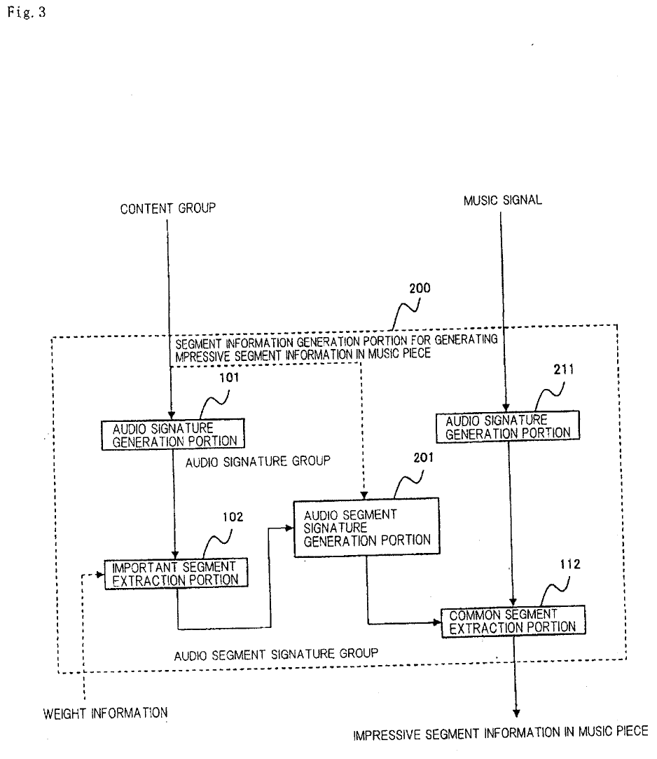

Hereinafter, a second exemplary embodiment of the present invention will be described with reference to drawings. FIG. 3 is a block diagram showing the second exemplary embodiment of the automatic segment extraction system in accordance with the present invention. The automatic segment extraction system shown in FIG. 3 includes segment information generation portion 200 for generating impressive segment information in a music piece.

Segment information generation portion 200 includes audio segment signature generation portion 201 in addition to the individual portions constituting the first exemplary embodiment and replaces the second audio signature generation portion 111 with second audio signature generation portion 211.

Segment information generation portion 200 generates segment information indicating an impressive segment in a music piece based on a music signal and a content group using the music piece internally. It should be noted that the same reference numerals as those in FIG. 2 are assigned to the same configuration portions as audio signature generation portion 101, important segment extraction portion 102, and common segment extraction portion 112 in accordance with the first exemplary embodiment and the description thereof is omitted.

When a content group is inputted into segment information generation portion 200, audio signature generation portion 101 and important segment extraction portion 102 generate an audio segment signature group in the same way as in the first exemplary embodiment.

In the following description, an audio segment signature generated by important segment extraction portion 102 is written as a first audio segment signature and a plurality of first audio segment signatures are written as a first audio segment signature group.

According to the second exemplary embodiment, important segment extraction portion 102 performs processing at high speed by simply comparing the individual audio signatures.

Audio segment signature generation portion 201 generates a second audio segment signature group containing a different kind of music feature value from the one generated by audio signature generation portion 101 from the first audio segment signature group.

The different kind of music feature value is, for example, a music feature value which is contained in the first audio segment signature but has a modified parameter thereof, only a portion of which is extracted from the music feature value, or the music feature value having another music feature value added thereto.

Audio segment signature generation portion 201 may generate a second audio segment signature group by converting the first audio segment signature group.

Alternatively, instead of directly converting the first audio segment signature group, audio segment signature generation portion 201 may receive only the time information from important segment extraction portion 102 and generate a music feature value directly from the inputted content group.

Audio signature generation portion 211 generates an audio signature containing the same kind of music feature value as the one generated by audio segment signature generation portion 201 from the inputted music signal.

Both the audio signature generated by audio signature generation portion 211 and the second audio segment signature group generated by audio segment signature generation portion 201 are inputted into common segment extraction portion 112.

The operation of common segment extraction portion 112 is the same as in the first exemplary embodiment. Common segment extraction portion 112 determines a common segment showing an impressive segment in a music piece from the outputs from audio segment signature generation portion 201 and audio signature generation portion 211 and generates time information (segment information) capable of identifying the common segment.

It should be noted that according to the second exemplary embodiment, common segment extraction portion 112 outputs time information capable of identifying the common segment by precisely comparing the second audio segment signature group and the audio signature of the music signal.

As described above, according to the second exemplary embodiment, in addition to an advantage in accordance with the first exemplary embodiment, high-speed processing can be achieved by performing a simple comparison between the audio signatures for the first audio signature comparison process that is carried out using a content group having a large number of repetitive processes and, at the same time, precise processing can be achieved for a comparison between the audio signature and the second audio segment signature group having a greatly reduced number of repetitive processes.

### Third Exemplary Embodiment

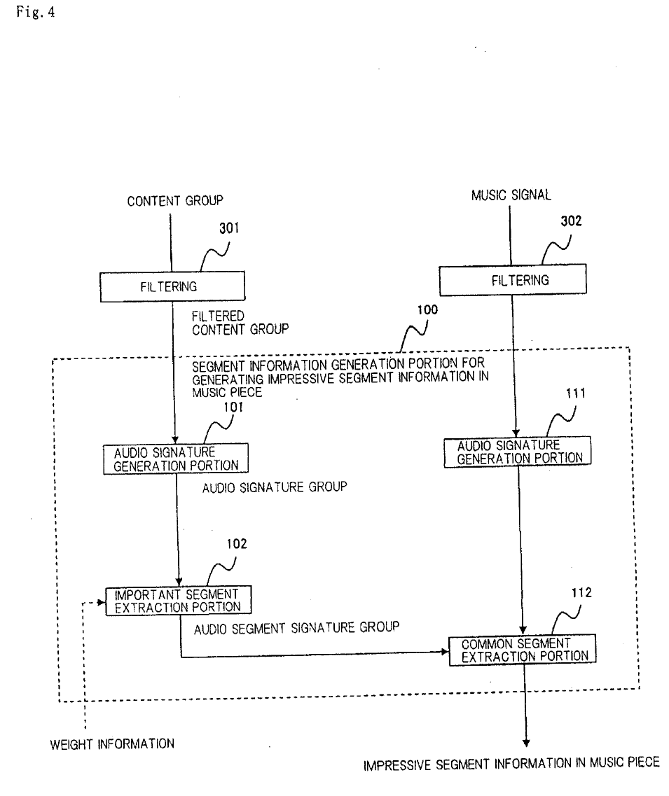

Hereinafter, a third exemplary embodiment of the present invention will be described with reference to drawings. FIG. 4 is a block diagram showing the third exemplary embodiment of the automatic segment extraction system in accordance with the present invention. The automatic segment extraction system shown in FIG. 4 includes segment information generation portion 100, first filtering portion 301 for processing an input signal, and second filtering portion 302.

It should be noted that FIG. 4 exemplifies segment information generation portion 100 used in the first exemplary embodiment as the segment information generation portion, but segment information generation portion 200 in the second exemplary embodiment may be used instead.

First filtering portion 301 has a function to cut off a signal of a specific band from a musical tone signal in a content group in order to reduce speech content and various special effects superimposed on a musical tone signal in a content group. In particular, a band rejection filter for rejecting only a signal of the band of a speech sound is a representative exemplary embodiment of first filtering portion 301.

Second filtering portion 302 has a function to cut off a signal of a specific band from the music signal.

Second filtering portion 302 may have the same frequency characteristic as first filtering portion 301 in order to prevent a malfunction of common segment extraction portion 112 as well as may have the same band cut off characteristic as partial inhibition or suppression of the low frequency range or high frequency range of a musical tone signal occurring at the time of recording a content group including a musical tone signal.

In this case, even if a part of the low frequency range or high frequency range of a musical tone signal included in the content group is cut off when a content group is recorded, it is possible to match the band of a musical tone signal inputted in audio signature generation portion 111 to the band of a musical tone signal included in the content group. Accordingly, it is possible to prevent a malfunction of common segment extraction portion 112.

According to the third exemplary embodiment, in addition to the advantages of the first and second exemplary embodiments, even though the content does not always have a scene in which only the music is played quietly, generation of impressive segment information in a music piece can be achieved with a high degree of probability.

### Fourth Exemplary Embodiment

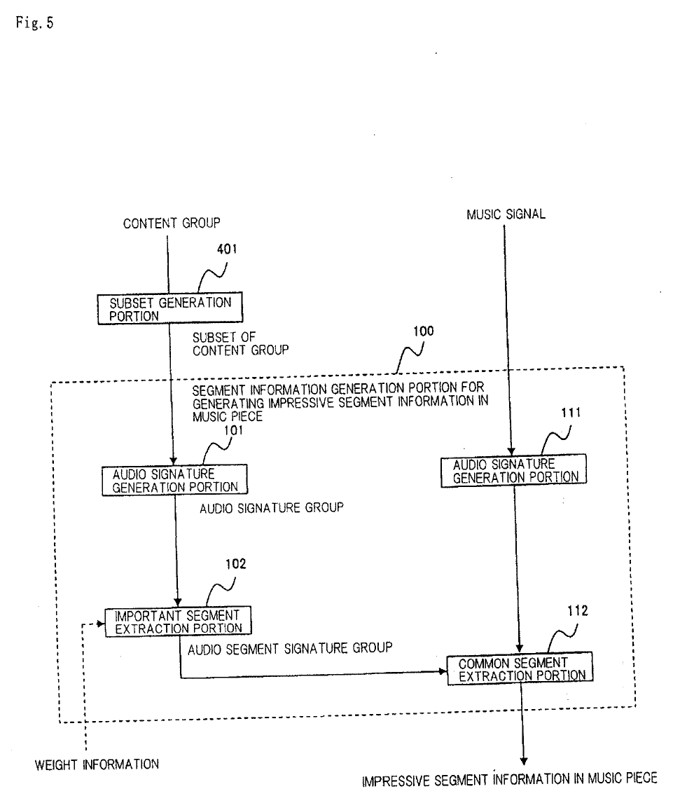

Hereinafter, a fourth exemplary embodiment of the present invention will be described with reference to drawings. FIG. 5 is a block diagram showing the fourth exemplary embodiment of the automatic segment extraction system in accordance with the present invention. The automatic segment extraction system shown in FIG. 5 includes segment information generation portion 100 and subset generation portion 401 for processing an inputted content group.

It should be noted that FIG. 5 exemplifies segment information generation portion 100 used in the first exemplary embodiment as the segment information generation portion, but segment information generation portion 200 used in the second exemplary embodiment may be used instead.

In addition, first filtering portion 301 and second filtering portion 302 shown in FIG. 4 may be added to the fourth exemplary embodiment.

Subset generation portion 401 generates a subset of an inputted content group. For example, subset generation portion 401 extracts a plurality of pieces of content information according to a predetermined criterion.

The subset refers to, for example, a collection of only the content of the TV broadcast programs belonging to the same series, a collection of only the content of almost overlapped viewer groups, and a collection of only the content related to a specific event.

The TV broadcast programs belonging to the same series are a series of TV broadcast programs having continuity such as two or more movies or dramas having the same central character and theme or a sports game played continuously for a certain period of time.

Viewers may be strongly impressed by the whole of various content groups, but in general, the impression received by viewers may often be strongly connected to a specific content group.

In addition to the advantages of the first, second and third exemplary embodiments, the fourth exemplary embodiment has an advantage in that it is capable of appropriately extracting a portion used repeatedly in the drama from a music piece used as the theme song in a specific drama program.

It should be noted that each of the above exemplary embodiments exemplifies a music signature as information indicating the feature value of an audio signal, but if the music piece includes a video such as a music clip for promotion, a configuration using a video signature instead of the audio signature may be used.

Further, if text information in sync with the music piece such as a lyric is attached to the music piece, the text content itself may be used as a signal signature for identification.

### INDUSTRIAL APPLICABILITY

The present invention can be applied to automatically extract an impressive segment from a music signal of the music.

For example, when the user is notified of information indicating that music piece has been retrieved as the result of a music database search, an impressive segment of the retrieved music piece is automatically extracted and the impressive segment can be played to notify the user instead of displaying the title with text on the screen.

This case can be applied to, for example, an application such as a music selection in a situation in which notification by display is disabled and is useful for a music terminal and the like for use in a car or an overcrowded train.

Alternatively, when a user selects a music piece for music selection at karaoke, instead of being notified the title, the user is notified of an automatically extracted impressive segment. Therefore, even if the user does not accurately remember the bibliographic information such as a title, the user can select the music piece by comparing the remembered phrase and the provided phrase.

Further, the present invention can be applied to an application such that when a user searches for sound effects for video editing or the like, widely used popular phrases can be automatically extracted to be presented to the user as an option.

1-24. (canceled)

25. An automatic segment extraction system which automatically extracts information indicating an impressive segment in a music piece from the music piece, comprising:
a frequent segment extraction portion which determines an audio segment occurring repeatedly in content information generated by using a portion of the music piece as a frequent segment and which extracts the frequent segment;
a common segment determination portion which determines whether or not an audio of said frequent segment exists in a music signal; and
a common segment output portion which outputs information capable of determining a segment of said music signal corresponding to said frequent segment if a determination is made that the audio of said frequent segment exists in said music signal.

26. The automatic segment extraction system according to claim 25, wherein
said frequent segment extraction portion generates audio segment identification information capable of identifying an individual segment of an audio signal in content information separated by a predetermined condition and extracts the audio segment identification information for determining said frequent segment as frequent segment identification information;
said common segment determination portion generates music segment identification information capable of identifying an individual segment of a music signal separated by a predetermined condition and compares said frequent segment identification information and said music segment identification information; and
if said frequent segment identification information matches any one of the pieces of said music segment identification information, said common segment output portion outputs information indicating said matched music segment identification information.

27. The automatic segment extraction system according to claim 26, wherein said audio segment identification information and said music segment identification information are information including a feature value;
said frequent segment extraction portion determines said frequent segment by comparing individual feature values contained in individual audio segment identification information;
said common segment determination portion compares the feature value contained in said frequent segment identification information and the individual feature value contained in individual music segment identification information; and
if the feature value contained in said frequent segment identification information matches any one of the individual feature values contained in said music segment identification information, said common segment output portion outputs information indicating said matched music segment identification information.

28. The automatic segment extraction system according to claim 27, further comprising a second extraction portion which generates second frequent segment identification information containing the same kind of feature values as the feature values contained in said music segment identification information based on the frequent segment identification information extracted by said frequent segment extraction portion, wherein
said common segment determination portion generates said music segment identification information containing feature values that are different from the feature values contained in the frequent segment identification information extracted by said frequent segment extraction portion and compares the feature values contained in said second frequent segment identification information and the individual feature values contained in said music segment identification information.

29. The automatic segment extraction system according to claim 25, wherein said frequent segment extraction portion extracts said frequent segment according to the inputted weight information.

30. The automatic segment extraction system according to claim 25, wherein said frequent segment extraction portion comprises a first filtering portion which restricts a band of an audio signal of said content information; and said common segment determination portion comprises a second filtering portion which restricts a band of an audio signal of said music signal.

31. The automatic segment extraction system according to claim 25, wherein said frequent segment extraction portion comprises a subset generation portion which extracts a plurality of pieces of content information according to a predetermined criterion.

32. The automatic segment extraction system according to claim 31, wherein said content information is a TV broadcast program and said subset generation portion extracts a TV broadcast program belonging to a same series.

33. An automatic segment extraction method for use in an automatic segment extraction system for automatically extracting information indicating an impressive segment in a music piece from the music piece, the method comprising:
determining an audio segment occurring repeatedly in content information generated by using a portion of the music piece as a frequent segment and extracting the frequent segment;
determining whether or not an audio of said frequent segment exists in the music signal; and
outputting information capable of determining a segment of said music signal corresponding to said frequent segment if a determination is made that the audio of said frequent segment exists in said music signal.

34. The automatic segment extraction method according to claim 33, wherein said determining the audio segment comprises generating audio segment identification information capable of identifying an individual segment of an audio signal in content information separated by a predetermined condition and extracting the audio segment identification information for determining said frequent segment as frequent segment identification information;
said determining whether or not the audio of said frequent segment exists in the music signal comprises generating music segment identification information capable of identifying an individual segment of a music signal separated by a predetermined condition and comparing said frequent segment identification information and said music segment identification information; and
if said frequent segment identification information matches any one of the pieces of said music segment identification information, said outputting comprises outputting information indicating said matched music segment identification information.

35. The automatic segment extraction method according to claim 34, wherein said audio segment identification information and said music segment identification information are information including a feature value;
said determining the audio segment comprises determining the frequent segment by comparing individual feature values contained in individual audio segment identification information;
said determining whether or not the audio of said frequent segment exists in the music signal comprises comparing the feature value contained in said frequent segment identification information and the individual feature value contained in individual music segment identification information; and
if the feature value contained in said frequent segment identification information matches any one of the individual feature values contained in said individual music segment identification information, said outputting comprises outputting information indicating said matched music segment identification information.

36. The automatic segment extraction method according to claim 35, further comprising generating second frequent segment identification information containing the same kind of feature values as the feature values contained in said music segment identification information based on the frequent segment identification information extracted by said frequent segment extraction step, wherein
said determining whether or not the audio of said frequent segment exists in the music signal comprises generating said music segment identification information containing feature values different from the feature values contained in the frequent segment identification information extracted by said determining the audio segment and comparing the feature values contained in said second frequent segment identification information and the individual feature values contained in said music segment identification information.

37. The automatic segment extraction method according to claim 33, wherein said determining the audio segment comprises extracting said frequent segment according to the inputted weight information.

38. The automatic segment extraction method according to claim 33, further comprising first restricting a band of an audio signal of said content information and second restricting a band of an audio signal of said music signal, wherein
said determining the audio segment comprises determining as said frequent segment a segment containing a portion of the audio signal occurring repeatedly in content information where the band of the audio signal is restricted by said first restricting the band of the audio signal of said content information and extracting said frequent segment; and
said determining whether or not the audio of said frequent segment exists in the music signal comprises determining whether or not the frequent segment extracted by said determining the audio segment exists in a music signal where the band of the audio signal is restricted by second restricting the band of the audio signal of said music signal.

39. The automatic segment extraction method according to claim 33, further comprising extracting a plurality of pieces of content information by a predetermined criterion, wherein
said determining the audio segment comprises determining as said frequent segment a segment containing a portion of an audio signal occurring repeatedly in a plurality of pieces of content information extracted by said extracting the plurality of pieces of content information and extracting said frequent segment.

40. The automatic segment extraction method according to claim 39, wherein said content information is a TV broadcast program and said extracting the plurality of pieces of content information comprises extracting a TV broadcast program belonging to a same series.

41. An automatic segment extraction program product for causing a computer to execute a process of automatically extracting information indicating an impressive segment in a music piece from the music piece, the program product causing said computer to execute:
a frequent segment extraction process of determining an audio segment occurring repeatedly in content information generated by using a portion of the music piece as a frequent segment and extracting the frequent segment;
a common segment determination process of determining whether or not an audio of said frequent segment exists in the music signal; and
a common segment output process of outputting information capable of determining a segment of said music signal corresponding to said frequent segment if a determination is made that the audio of said frequent segment exists in said music signal.

42. The automatic segment extraction program product according to claim 41, wherein
said frequent segment extraction process comprises generating audio segment identification information capable of identifying an individual segment of an audio signal in content information separated by a predetermined condition and extracting the audio segment identification information for determining said frequent segment as frequent segment identification information;
said common segment determination process comprises generating music segment identification information capable of identifying an individual segment of a music signal separated by a predetermined condition and comparing said frequent segment identification information and said music segment identification information; and
if said frequent segment identification information matches any one of the pieces of said music segment identification information, said common segment output process comprises outputting information indicating said matched music segment identification information.

43. The automatic segment extraction program product according to claim 42, wherein
said audio segment identification information and said music segment identification information are information including a feature value;
said frequent segment extraction process comprises determining the frequent segment by comparing individual feature values contained in the individual audio segment identification information;
said common segment determination process comprises comparing the feature value contained in said frequent segment identification information and the individual feature value contained in the individual music segment identification information; and
if the feature value contained in said frequent segment identification information matches any one of the individual feature values contained in said music segment identification information, said common segment output process comprises outputting information indicating said matched music segment identification information.

44. The automatic segment extraction program product according to claim 43, further causing said computer to execute a second frequent segment extraction process of generating second frequent segment identification information containing the same kind of feature values as the feature values contained in said music segment identification information based on the frequent segment identification information extracted by said frequent segment extraction process, wherein
said common segment determination process comprises generating the music segment identification information containing feature values different from the feature values contained in the frequent segment identification information extracted by said frequent segment extraction process and comparing the feature values contained in said second frequent segment identification information and the individual feature values contained in said music segment identification information.

45. The automatic segment extraction program product according to claim 41, wherein said frequent segment extraction process extracts said frequent segment according to the inputted weight information.

46. The automatic segment extraction program product according to claim 41, further causing said computer to execute a first filtering process of restricting a band of an audio signal of said content information and a second filtering process of restricting a band of an audio signal of said music signal, wherein
said frequent segment extraction process comprises determining as said frequent segment a segment containing a portion of an audio signal occurring repeatedly in content information where the band of an audio signal is restricted by said first filtering process and extracting said frequent segment; and
said common segment determination process comprises determining whether or not the frequent segment extracted by said frequent segment extraction step exists in a music signal where the band of an audio signal is restricted by said second filtering process.

47. The automatic segment extraction program product according to claim 41, further causing said computer to execute a subset generation process of extracting a plurality of pieces of content information according to a predetermined criterion, wherein said frequent segment extraction process comprises determining a segment containing a portion of an audio signal occurring repeatedly in a plurality of pieces of content information extracted by said subset generation process as said frequent segment and extracting said frequent segment.

48. The automatic segment extraction program product according to claim 47, wherein said content information is a TV broadcast program and said subset generation process comprises extracting a TV broadcast program belonging to the same series.

49. An automatic segment extraction system which automatically extracts information indicating an impressive segment in a music piece from the music piece, comprising:
frequent segment extraction means for determining an audio segment occurring repeatedly in content information generated by using a portion of the music piece as a frequent segment and extracting the frequent segment;
common segment determination means for determining whether or not an audio of said frequent segment exists in a music signal; and
common segment output means for outputting information capable of determining a segment of said music signal corresponding to said frequent segment if a determination is made that the audio of said frequent segment exists in said music signal.

50. A computer readable recording medium on which an automatic segment extraction program is embedded, said program for causing a computer to execute a process of automatically extracting information indicating an impressive segment in a music piece from the music piece, the program causing said computer to execute:
a frequent segment extraction process of determining an audio segment occurring repeatedly in content information generated by using a portion of the music piece as a frequent segment and extracting the frequent segment;
a common segment determination process of determining whether or not an audio of said frequent segment exists in the music signal; and
a common segment output process of outputting information capable of determining a segment of said music signal corresponding to said frequent segment if a determination is made that the audio of said frequent segment exists in said music signal.
